(19) United States
(12) Patent Application Publication
(10) Pub. No.: US 2025/0335483 A1
(43) Pub. Date: Oct. 30, 2025

(54) Section-based chunking technique for Retrieval-Augmented Generation (RAG) with Large Language Models (LLMs)

(71) Applicant: Ciena Corporation, Hanover, MD (US)

(72) Inventors: Christopher Barber, Ottawa (CA); Ahmed Khaled, Oulu (FI); Shervin Shirmohammadi, Ottawa (CA)

(73) Assignee: Ciena Corporation, Hanover, MD (US)

(21) Appl. No.: 18/651,241

(22) Filed: Apr. 30, 2024

(51) Int. Cl. G06F 16/33; G06F 16/31

(52) U.S. Cl. CPC G06F 16/3344; G06F 16/316; G06F 16/3347

(57) ABSTRACT

Systems, methods, and non-transitory computer-readable media are provided for conducting user query searches. According to one implementation, a process includes a step of, in response to receiving a user query directed to subject information retrievable from documentation stored in a private database, using a section-based chunking procedure to obtain, from the private database, a relevant section of the documentation as context. The process further includes a step of feeding the user query and the relevant section as context to a Large Language Model (LLM).

### FIELD OF THE DISCLOSURE

The present disclosure generally relates to Large Language Models (LLMs). More particularly, the present disclosure relates to systems and methods for chunking documentations based on predefined sections for context retrieval in Retrieval-Augmented Generation (RAG) with LLMs.

### BACKGROUND

A Large Language Model (LLM) is an Artificial Intelligence (AI) model with the ability to perform various Natural Language Processing (NLP) functions, such as Generative AI (GenAI) processes. A few examples of popular LLMs include OpenAI's ChatGPT, Microsoft's Copilot, and Meta's LLaMa. An LLM can be extremely powerful at answering questions about publicly available data on which it has been trained. However, when a query involves a question about private information excluded from a pre-training step, the LLM may reply that it does not know the answer, or it may provide a “hallucinated” answer. One possible approach to avoiding this issue is to supply the LLM with relevant private information along with the search query. This approach, for example, may be performed using a method referred to as Retrieval-Augmented Generation (RAG). Using a RAG technique, a RAG model retrieves relevant documents from a private database and then passes them to an LLM, allowing the LLM to generate an output based on the retrieved private information. However, a primary challenge with RAG methods is in deciding what context of the private information to feed to the LLM.

### BRIEF SUMMARY

In various embodiments, the present disclosure includes a process having steps for conducting a query search, a system including at least one processor and memory with instructions that, when executed, cause the at least one processor to implement the steps for conducting the query search, and a non-transitory computer-readable medium having instructions stored thereon for programming at least one processor to perform the steps for conducting the query search.

According to one implementation, in response to receiving a user query directed to subject information retrievable from documentation stored in a private database, a process includes a step of using a section-based chunking procedure to obtain, from the private database, a relevant section of the documentation as context. The process further includes a step of feeding the user query and the relevant section as context to a Large Language Model (LLM).

In some embodiments, the section-based chunking procedure uses Retrieval-Augmented Generation (RAG) to parse the user query and retrieve the relevant section. Also, in some embodiments, the section-based chunking procedure may use an inherent structure of the documentation, such as sections, subsections, paragraphs, bullet point lists, and/or tables.

Before receiving the user query, the process may further include the step of performing a data preparation procedure to separate the documentation into sections, whereby each section may include content under a respective section header. The data preparation procedure may further include a step of dividing the content of each section into one or more of paragraphs, table entries, and subsections. Also, the data preparation procedure may further include the step of embedding a content value of each section as vectors in the private database to enable the documentation to be searched by section.

In some embodiments, the process may further include a step of embedding the user query as a query vector, wherein the step of obtaining the relevant section of the documentation as context may include searching the private database for the semantically closest vectors to the query vector. The step of obtaining the relevant section may also further include a) detecting a header of the semantically closest vectors and b) searching the private database for subsections having headers that match the header of the semantically closest vectors.

The section-based chunking procedure, according to some implementations, includes obtaining the relevant section of the documentation in a manner that is unrelated to the conventional sliding window procedure. In some embodiments, the size (e.g., number of characters) of the user query and relevant section is configured to fall within an input token limit (e.g., 8 k) of an LLM. Also, in some embodiments, the private database may be a vector store. The process may be performed by a server and/or a retriever, based on various implementations.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a diagram illustrating a query system, according to various embodiments of the present disclosure.

FIG. 2 is a block diagram illustrating a computing system of the user device shown in FIG. 1, according to various embodiments.

FIG. 3 is a block diagram illustrating a computing system of the server and/or retriever shown in FIG. 1, according to various embodiments.

FIG. 4 is a diagram showing an example of private files stored on the vector store shown in FIG. 1.

FIGS. 5A and 5B are diagrams showing examples of a search query and corresponding system message.

FIG. 6 is a diagram illustrating an example of a window-based chunking procedure.

FIG. 7 is a diagram illustrating an example of search results using the window-based chunking procedure associated with FIG. 6.

FIG. 8 is a diagram illustrating an example of a section-based chunking procedure, according to various embodiments of the present disclosure.

FIG. 9 is a diagram illustrating an example of search results using the section-based chunking procedure associated with FIG. 8.

FIG. 10 is a flow diagram illustrating a process for performing a query search, according to various embodiments.

### DETAILED DESCRIPTION

The present disclosure relates to systems and methods for performing search queries for a user. Query systems described herein may include Large Language Models (LLMs) and Generative Artificial Intelligence (GenAI). In particular, the query systems and methods described herein may use a retrieving strategy, such as Retrieval-Augmented Generation (RAG) for specifically obtaining relevant context from documents in the vector store. The relevant context can then be supplied to an LLM, along with the search query, to enable the LLM to provide more accurate answers. In particular, the query systems and methods focus on providing the most relevant sections of the documents for a given query.

Again, LLMs have been shown to be extremely powerful at answering questions about the data on which they have been trained. However, because they are typically trained on publicly available data, they have no knowledge of private information that would have been excluded from the training data. As described herein, private information may include anything not publicly available and not in the training data for an LLM. A simple example of private information may include documentation which may be confidential. Thus, suppose a user wanted to ask an LLM (e.g., ChatGPT) a question like “How do I install X onto AWS EKS?” (where “X” refers to some specific software platform and AWS EKS is Amazon Web Services Elastic Kubernetes Service). Assume the X documentation that contains the relevant information is not public, the LLM would have no knowledge of it and would either hallucinate an answer that sounds right or say it does not know.

There are generally two approaches to adding private information into pre-trained LLMs. One is to fine-tune the LLM by explicitly re-training it with private data, which can be expensive and complex. Another approach is to provide the relevant private information in the user prompt when asking the question, also known as RAG. For example, RAG can combine a pretrained Dense Passage Retrieval (DPR) model with an LLM. The RAG models can retrieve relevant documents, pass them to an LLM, then marginalize the results to generate outputs.

An application of a RAG model may include querying large amounts of documentation with plain text questions. For example, a user query may be “How do I install X onto AWS EKS?” A retriever may be configured to search through the available documentation for X to find the relevant information (or “context”) that can be used to answer the query. The context and the original user query can then be fed into the prompt of a pre-trained LLM (e.g., ChatGPT), where the LLM uses the given context to answer the query.

### Context Challenge of RAG Models

However, the primary challenge of this RAG method is in how to decide what context to feed to the LLM. LLMs have a pre-defined input token limit, which means that there is a limit to the number of characters (e.g., words) that can be fed into the prompt of the LLM. Thus, it is often infeasible or even impossible to feed a document with hundreds of pages of text into the LLM prompt. Even if it were possible, feeding too much content in the context would greatly increase the time to return a response and would increase the possibility of the LLM returning an answer with irrelevant information. On the other hand, feeding the LLM with insufficient context can lead to hallucinations or misunderstandings.

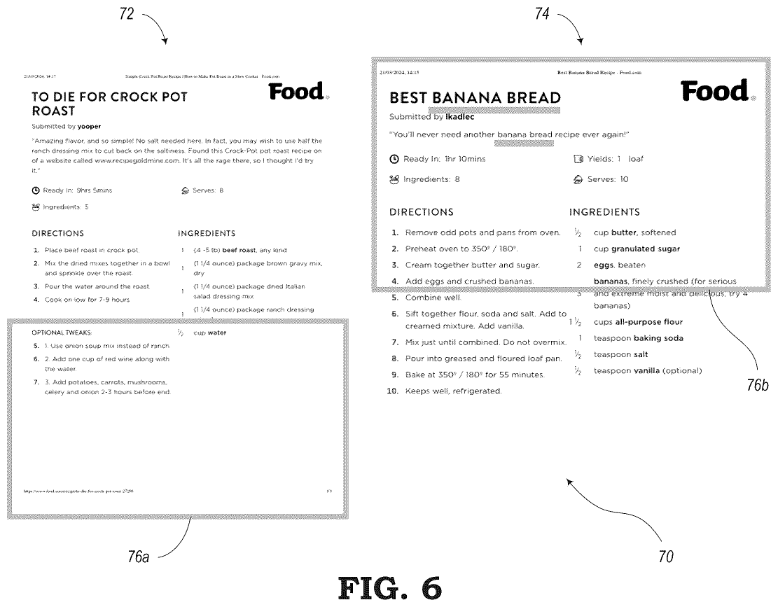

Thus, the challenge at this point can be tackled via a method called “chunking.” With chunking, a document is broken up into subsets of text, each of which can fit within the token limit of the LLM's input prompt. This is can be done using a “sliding window” on the text, where a window of text with the highest semantic match to the query is fed into the LLM as the context. However, the problem with this sliding window chunking method is that it does not consider the structure of the document. Often, technical documentation is split up into discrete sections, subsections, paragraphs, numbered or bullet point lists, tables, etc., where a fixed sliding window would either contain information from irrelevant sections (as shown in an example illustrated in FIG. 6) or cut off information from the same section which could be relevant (also shown in the example of FIG. 6). As an analogy, think of this example as providing a single page from a textbook. It might contain the information the user needs, but it might also be truncated and missing other important information from the same section or contain information from another section which is not relevant.

### Solutions to the Sliding Window Problem

Therefore, the systems and methods of the present disclosure are configured to overcome the problems with the “sliding window” technique, used in RAG chunking methods. When performing a documentation query using a RAG, the embodiments of the present disclosure are configured to provide a method of chunking a document based on the inherent structure of the document, rather than a sliding window. In this way, the context provided to the LLM would be a complete, coherent section of the document, rather than an arbitrary slice, which thereby improves the understandability of the context for the LLM. Below are two methods-firstly for preparing the documentation data and secondly for performing inference on a user's query.
I. Documentation Data Preparation Method:
(A) Break the document up into sections, where a section is defined as all of the content underneath a given section header. If there exists a hierarchy of subsections, the method may flatten the hierarchy such that each section contains only its content (e.g., paragraphs and tables) and no subsections.
(B) Within each section, break the contents up into a list of paragraphs and table entries. For convenience, the method may extract and store the entire table as a Comma-Separated Value (CSV) file. The step may represent each paragraph or table entry as a JSON object with its content and other keys with metadata:
(1) Content—the actual text of the paragraph or table entry
(2) Table path (if the content comes from a table)—the path to the csv representation of that table (if not a table, this is an empty string)
(3) Type-specifies whether the content comes from a table or paragraph. Note that bullet point or numbered list entries may also be considered as “paragraphs”
(4) Header—the title of the section containing this content
(C) Embed the Content value of each paragraph or table as a vector, and store each Content vector along with the other metadata as columns into a relational database
II. Inference Method (the following steps may be configured to be executed each time a user enters a query about their documentation into the system):
(A) Embed the user's query as a vector (e.g., embedding is described in more detail below). Search a vector store for the semantically closest Content vectors to the user's query. This step will yield the paragraph or table entry which is most similar to the question being asked.
(B) Read the Header of the matched Content vectors (e.g., may be referred to as a “matched_header”).
(C) Search the database for all paragraphs and tables with the Header equal to “matched_header.” This step is configured to yield all of the content of the section that contains the semantically closest Content vectors. For tabular data, the method may read the entire table from the csv specified by “Table Path,” which may be faster than rebuilding it from the table entries.
(D) Add the content of the matched section to the LLM prompt along with the user's query and ask the LLM to answer the question using the available context.

### Query System

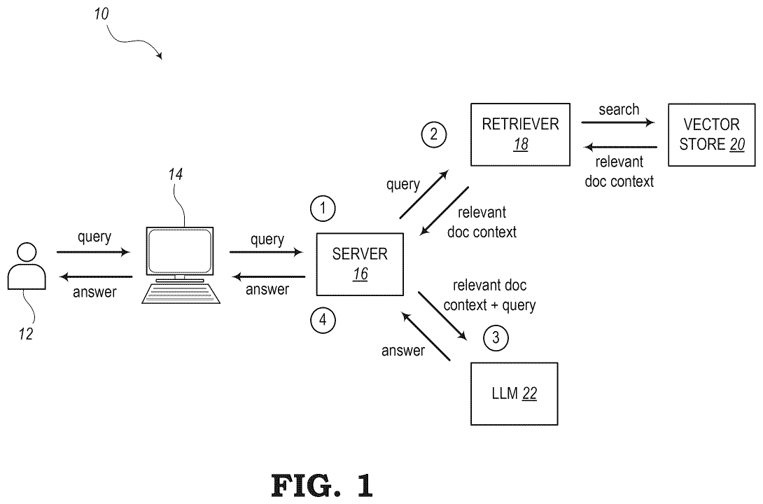

FIG. 1 is a diagram illustrating an embodiment of a query system 10, which may be configured as a GenAI documentation query system. As shown in FIG. 1, the query system 10 involves allowing a user 12 to enter a query into a user device 14 (e.g., computer, tablet, mobile device, etc.) having an applicable search app. The user device 14 forwards the query to a server 16, which is configured to process the query and provide a proper answer back to the user device 14. Those skilled in the art will recognize the server 16 can include multiple servers, be configured as a cloud service, etc. In some cases, the server 16 may determine that the answer can be obtained from publicly available resources over the Internet and can provide answers according to ordinary searching techniques. However, if the query involves a subject having information stored in a private database, the server 16 is configured to use an alternative method as opposed to a regular Internet search.

For utilizing private information, the server 16 sends the query to a retriever 18, which may include a search engine. Also, the retriever 18 may be configured as a RAG component having the capabilities described in the present disclosure for overcoming the context retrieving issues associated with conventional systems. That is, the retriever 18 may be configured to utilize a section-based chunking technique as opposed to the problematic window-based technique. Thus, the retriever 18 performs a search of a vector store 20 (e.g., private documentation library, private database, etc.) and therefore retrieves relevant documentation context from the vector store 20.

Next, the server 16 is configured to provide the relevant documentation context (obtained from the vector store 20), along with the original user query to an LLM 22. Thus, the server 16 can create a prompt to the LLM 22 that includes both the relevant material and the query. The server 16 may phrase the prompt with specific instructions and the relevant context data (e.g., based on a “section” of the associated private data) to enable the LLM 22 to provide a proper answer. It should be noted that by using a section-based retrieval or chunking process, the appropriate section of the private information can lead the LLM 22 to create an answer that is relevant with respect to the query and that includes no hallucinations. The server 16 can then forward the answer to the user device 14.

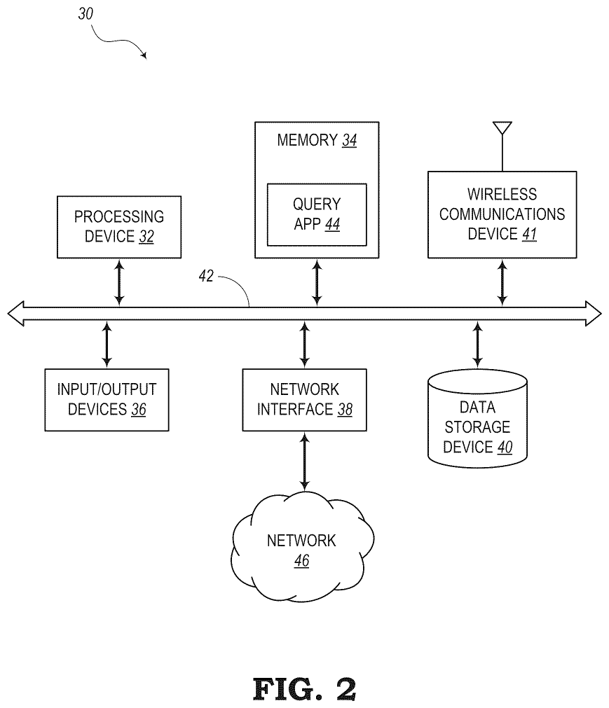

FIG. 2 is a block diagram illustrating an embodiment of a computing system 30 associated with the user device 14 shown in FIG. 1. The computer system 30 includes a processing device 32, memory 34, Input/Output (I/O) devices 36, a network interface 38, a data storage device 40, and a wireless communications device 41 (e.g., radio system, cellular communications system, Wi-Fi communications system, Bluetooth system, etc.). The computer system 30 is configured to perform various functions and tasks through the coordinated operation of its constituent components 32, 34, 36, 38, 40, 41 via a suitable local bus interface 42. In operation, the computer system 30 may be configured to utilize its processing capabilities, memory resources, input/output interfaces, network connectivity, data storage, and wireless communications to execute software applications, process data, interact with users, and exchange information with external devices and networks.

The processing device 32, such as a central processing unit (CPU), executes instructions stored in memory 34 to carry out computational tasks and to manage the operation of the computer system 30. The memory 34 includes volatile and non-volatile storage components, providing temporary storage for data and instructions during execution. It comprises random access memory (RAM) for fast access and read-only memory (ROM) for storing essential system software. The computer system 30 may be configured to interface with users and external peripherals through the I/O devices 36. For example, input devices may include keyboards, mice, touchscreens, and other sensors, while output devices may encompass displays, printers, speakers, actuators, etc.

The network interface 38 may be configured to facilitate communication with external networks and devices, such as network 46 (e.g., the Internet). The network interface 38 enables the computer system 30 to send and receive data over wired or wireless connections. It supports various communication protocols such as Ethernet, Wi-Fi, Bluetooth, and cellular networks. The data storage device 40 (e.g., database, data store, etc.) is configured to store persistent data and system files, providing long-term storage capacity. It may include hard disk drives (HDDs), solid-state drives (SSDs), optical discs, and/or cloud storage services. The wireless communications device 41 may be configured to allow the computer system 30 to transmit and receive data wirelessly over radio frequencies, such as by using one or more antennas. It may be configured to support various communications standards, such as IEEE 802.11 (Wi-Fi), Bluetooth, cellular technologies, etc., enabling connectivity to wireless networks and peripheral devices.

The computing system 30 may include a query app 44 for enabling the user 12 to search for information, such as in the form of a natural language query normally associated with LLMs. The query app 44 may be incorporated in the memory 34 as software or firmware and/or may be incorporated in the processing device 32 as hardware. When implemented as software or firmware, the query app 44 may include computer-readable logic stored in a non-transitory computer-readable medium, whereby the logic may include instructions enabling or causing the processing device 32 to perform various functions as described in the present disclosure for conducting a search query for the user 12. As described with respect to FIG. 1, the query may be communicated in any suitable manner to the server 16, which can perform specific searches, as described with respect to the various embodiments of the present disclosure, and then provide an appropriate answer to the query.

### Server and Receiver

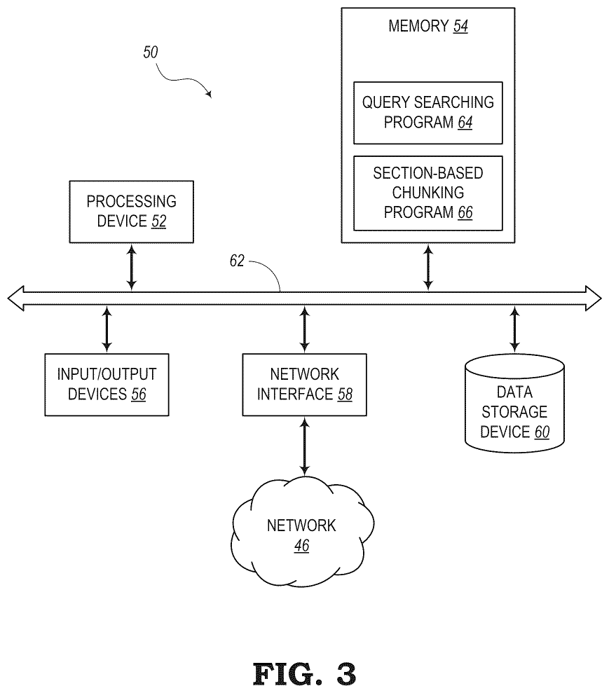

FIG. 3 is a block diagram illustrating a computing system 50, which may represent the components and functionality of one or both of the server 16 and/or retriever 18. The computer system 50 includes a processing device 52, memory 54, I/O devices 56, a network interface 58, and a data storage device 60. The computer system 50 is configured to perform various functions and tasks through the coordinated operation of its constituent components 52, 54, 56, 58, 60 via a local bus interface 62 in a manner similar to the procedures described with respect to the computing system 30 of FIG. 2. In operation, the computer system 50 may also be configured to utilize its processing capabilities, memory resources, input/output interfaces, network connectivity, and data storage to execute software applications, process data, interact with users, and exchange information with external devices and networks.

Furthermore, the computing system 50 includes a query searching program 64 configured to perform search functions based on a query received from a corresponding user devices (e.g., user device 14). Also, the computing system 50 includes a section-based chunking program 66 configured to retrieve relevant information (e.g., using RAG methods) from a vector database (e.g., vector store 20) when a search query involves specific reference to private information that is not normally publicly available. The programs 64, 66 may be stored in memory 54 or other non-transitory computer-readable media and may include instructions for enabling the processing device 52 to perform the searching and chunking functionality described herein.

In particular, the systems and methods of the present disclosure are configured to use the inherent structure of a document to provide a more complete context as a complete section of the documentation. Exploiting the structure of documents allows the dividing of the information into distinct sections. The query searching program 64 and section-based chunking program 66 can be run as software on any server (e.g., server 16, retriever 18, etc.) with sufficient resources and access to the LLM 22 (either via an external API or a locally deployed model) and access to a set of documentation (via the vector store 20 or other suitable database). The programs 64, 66 employed herein can consider the structure of the documentation when returning the context to the LLM 22.

Also, those skilled in the art will appreciate while the computing system 50 is illustrated as a single device that the present disclosure contemplates any implementation for implementing the functions of the server 16, the retriever 18, the vector store 20, and the LLM 22. That is, these can be deployed in a cloud via cloud services, across multiple machines, virtual machines, clusters, etc.

### Vector Store

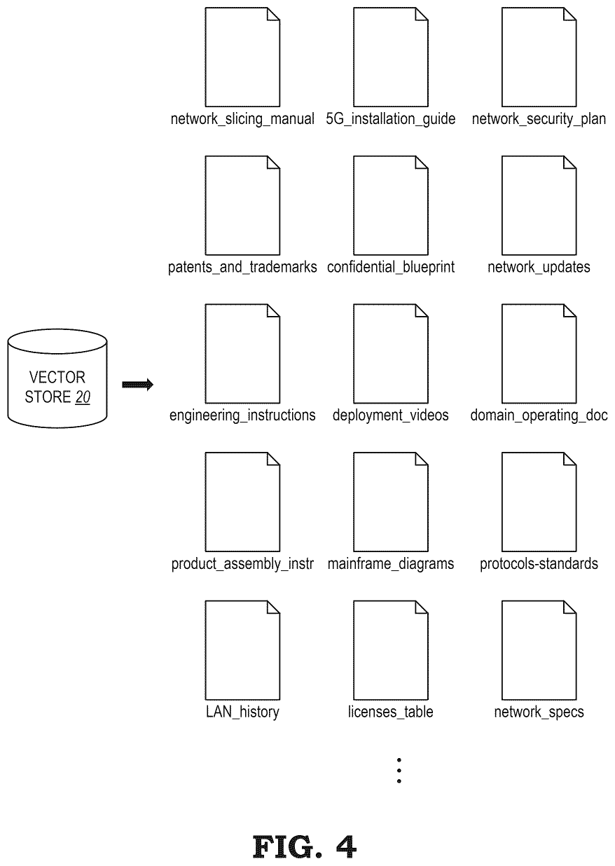

FIG. 4 is a diagram showing an example of private files stored on the vector store 20 shown in FIG. 1. Again, the vector store 20 may be configured to store files, tables, guides, instructions, etc. that may be private or sensitive in nature and would normally not be shared with or accessible by someone outside a specific computing domain. For example, the vector store 20 may be part of Local Area Network (LAN) or domain associated with a specific corporation, business, company, organization, enterprise, university, agency, etc. Some examples of the files stored in the vector store 20, as shown in FIG. 4, may include network slicing guides, installation guides, security plans, lists of parts of devices and equipment that may be proprietary, confidential design plans or blueprints of various systems and devices of the organization or network, operating guides, engineering or technician instructions, deployment instructions, network or equipment updates, assembly instructions, technical journals, protocols, standards, specifications, historical information, license information, patents, trademarks, copyrights, etc.

The vector store 20 (e.g., vector database management system (VDBMS), vector database, etc.) is configured to store vectors (i.e., fixed-length lists of numbers) along with other data items. In operation during a search query, the vector store 20 may utilize one or more Approximate Nearest Neighbor (ANN) algorithms, such that the retriever 18 can search the records with a query vector to retrieve the closest matching database document.

Vectors are mathematical representations of data in a high-dimensional space, where each dimension corresponds to an aspect, feature, or characteristic of the data. For example, in some cases, the number of dimensions may be on the order of hundreds, thousands, or even tens of thousands, depending on the complexity of the data being represented. A vector's position in the high-dimensional space represents its various aspects, features, or characteristics. The records stored in the vector store 20 may include words, phrases, entire documents, images, audio, video, and other types of data formats that can be vectorized using Machine Learning (ML) processes. The vectorization processes may include feature extraction, deep learning, and/or embedding techniques.

The retriever 18 can compute a prompt vector associated with the search query. Then, the retriever 18 can find a record in the vector store 20 that most closely matches the prompt vector. In this way, the retriever 18 can retrieve relevant information from the vector store 20 related to the prompt. Again, with private information in the vector store 20 (e.g., associated with sensitive material stored in a domain), the retriever 18 may implement a RAG method.

### Embeddings

In some embodiments of the present disclosure, the RAG methods may include an ML embedding technique for embedding the documentation in the vector store 20. The embedding procedure includes preparing the documents for searching. Embeddings are numerical representations of real-world objects that ML and AI systems can use to understand complex knowledge as a human would do. Embeddings convert real-world objects into complex mathematical representations that capture inherent properties and relationships between real-world data. The entire process may be automated using ML processes, where the ML training methods may be used for creating embeddings during training and then using them as needed during inference.

Embeddings enable deep-learning models to understand real-world data domains more effectively. They simplify how real-world data is represented while retaining the semantic and syntactic relationships. This allows machine learning algorithms to extract and process complex data types and enable innovative Al applications.

Embeddings may reduce data dimensionality. Data scientists can use embeddings to represent high-dimensional data in a low-dimensional space. In data science, the term dimension typically refers to a feature or attribute of the data. Higher-dimensional data in AI refers to datasets with many features or attributes that define each data point. This can mean tens, hundreds, or even thousands of dimensions. For example, an image can be considered high-dimensional data because each pixel color value is a separate dimension.

When presented with high-dimensional data, deep-learning models require more computational power and time to learn, analyze, and infer accurately. Embeddings reduce the number of dimensions by identifying commonalities and patterns between various features. This consequently reduces the computing resources and time required to process raw data.

Embedding methods can be used to train LLMs and can improve data quality when training. For example, data scientists use embeddings to clean the training data from irregularities affecting model learning. ML engineers can also repurpose pre-trained models by adding new embeddings for transfer learning, which requires refining the foundational model with new datasets. With embeddings, engineers can fine-tune a model for custom datasets from the real world.

Embeddings can also enable deep learning and GenAI applications. Different embedding techniques applied in neural network architecture allow accurate AI models to be developed, trained, and deployed in various fields and applications. For example, with “image” embeddings, engineers can build high-precision computer vision applications for object detection, image recognition, and other visual-related tasks. With “word” embeddings, natural language processing software can more accurately understand the context and relationships of words. With “graph” embeddings, related information can be extracted and categorized from interconnected nodes to support network analysis. Computer vision models, AI chatbots, and AI recommender systems all use embeddings to complete complex tasks that mimic human intelligence.

Regarding embeddings with respect to vectors, ML models cannot interpret information intelligibly in their raw format and require numerical data as input. They can use neural network embeddings to convert real-word information into numerical representations or vectors. Again, these vectors are numerical values that represent information in a multi-dimensional space and can help ML models to find similarities among sparsely distributed items.

Embeddings can vectorize objects into a low-dimensional space by representing similarities between objects with numerical values. Neural network embeddings ensure that the number of dimensions remains manageable with expanding input features. Input features are traits of specific objects an ML algorithm is tasked to analyze. Dimensionality reduction allows embeddings to retain information that ML models use to find similarities and differences from input data. Data scientists can also visualize embeddings in a two-dimensional space to better understand the relationships of distributed objects.

Engineers use neural networks to create embeddings. Neural networks consist of hidden neuron layers that make complex decisions iteratively. When creating embeddings, one of the hidden layers learns how to factorize input features into vectors. This occurs before feature processing layers. This process is supervised and guided by engineers with the following steps:
(1) Engineers feed the neural network with some vectorized samples prepared manually.
(2) The neural network learns from the patterns discovered in the sample and uses the knowledge to make accurate predictions from unseen data.
(3) Occasionally, engineers may need to fine-tune the model to ensure it distributes input features into the appropriate dimensional space.
(4) Over time, the embeddings operate independently, allowing the ML models to generate recommendations from the vectorized representations.
(5) Engineers continue to monitor the performance of the embedding and fine-tune with new data.

### User Search Query

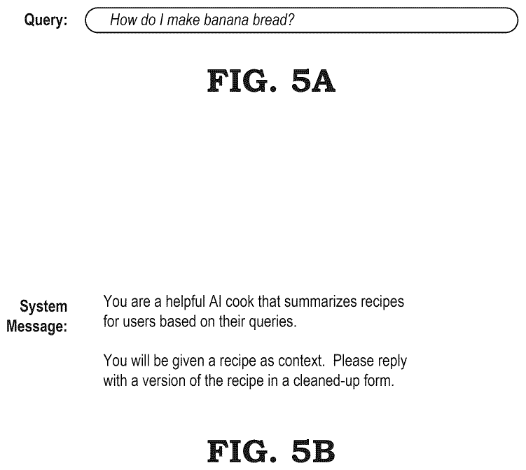

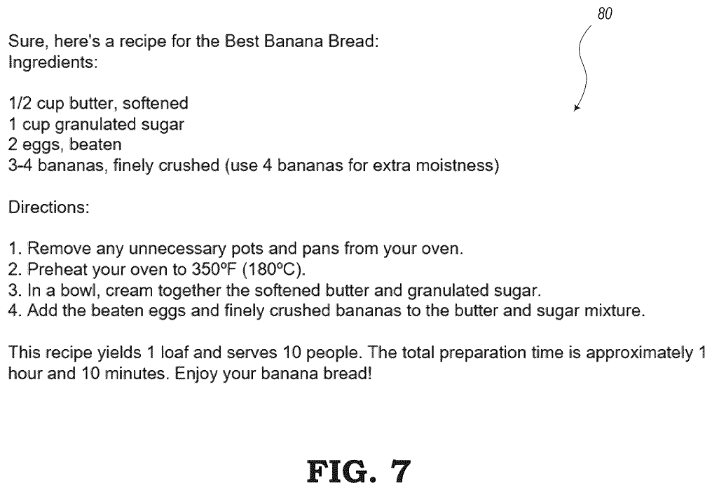

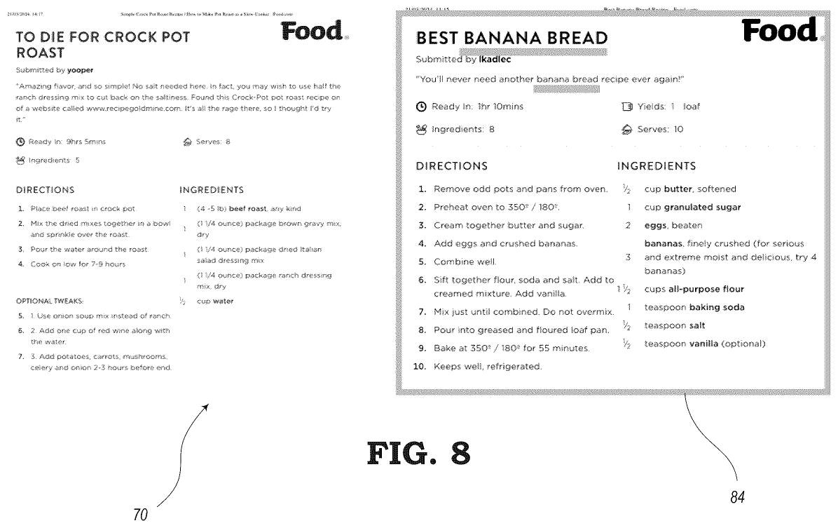

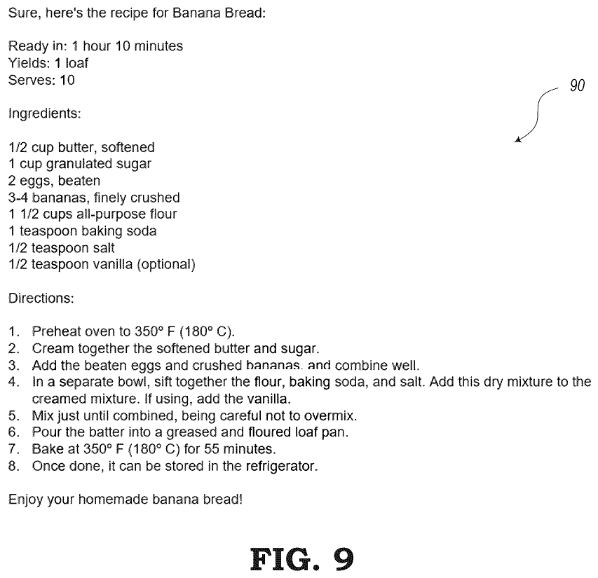

FIGS. 5A and 5B are diagrams showing examples of a search query and corresponding system message. A user may enter a query on a Graphical User Interface (GUI) or other input component of the user device 14. In this example, the user enters the query “How do I make banana bread?” The server 16 and/or retriever 18 may recognize this query as a request for a recipe and may create a system message for the LLM 22 reading, “You are a helpful AI cook that summarizes recipes for users based on their queries. You will be given a recipe as context. Please reply with a version of the recipe in a cleaned-up form.” It should be noted that, based on the retrieval strategy implemented in this example, the LLM 22 may come up with a number of different responses. For example, FIGS. 6 and 7 represent a “window-based” retrieval or chunking strategy, whereas FIGS. 8 and 9 represent a “section-based” chunking strategy according to the embodiments of the present disclosure.

Note, this example of “How do I make banana bread?” is likely in the training data of any LLM. However, for the sake of illustration of the present disclosure, assume this is in private information not included in the training data and requires RAG and input from private information. The following describes the sliding window and the present disclosure with reference to this query, namely “How do I make banana bread?”

### Sliding Window Technique

FIG. 6 is a diagram illustrating an example of pages of a cookbook 70, which may be stored in the vector store 20. On one page 72, a recipe for “To Die for Crock Pot Roast” is provided. On the next page 74 of the cookbook is a recipe for “Best Banana Bread.” From a human perspective, it may be noted that the most pertinent information is on this next page 74. However, when a window-based chunking procedure is executed, the text before and after the key phrase “banana bread” are obtained. In other words, the window-based chunking procedure obtains a sliding window 76 (including portions 76a and 76b) and does not implement any type of dividing mechanism for separating one recipe from another. Instead, this procedure simply takes a portion of the text before the key phrase and a portion of the text after the key phrase. As a result of the window-based chunking strategy of FIG. 6, the somewhat arbitrarily obtained sliding window 76 provides the best match, even though it starts at the end of the one page 72 (in the middle of one recipe) and ends in the middle of the next page 74 (in the middle of another recipe). Therefore, this procedure can include irrelevant information (i.e., portion 76a) as well as exclude relevant information (portion of the second recipe after the portion 76b of the sliding window).

FIG. 7 is a diagram illustrating an example of search results 80 using the window-based chunking procedure associated with FIG. 6. It may be noted that the about half of the directions and about half of the ingredients from the “Best Banana Bread” recipe have been omitted, since they were not included in the window 76a, 76b. As shown in this example, the resulting recipe is missing multiple steps that were missed during the chunking procedure.

### Section-Based Chunking Technique

FIG. 8 is a diagram illustrating the same example of the cookbook 70, except that a “section-based” chunking procedure is implemented instead. Also, the same query and system message of FIGS. 5A and 5B may be provided as a prompt. By pre-sectioning the documentation of the cookbook 70, each recipe may be divided up as its own section. In some embodiments, the sectioning of portions of a document may include separating by chapter, by page, by paragraph, by heading, or other suitable divisions. Thus, in response to the query, the retriever 18 is configured to chunk by section (or by “recipe” in this example). In this way, the retriever 18 can return the entire section 84 (i.e., entire recipe) as depicted in the block. The retriever 18 finds that this section 84 contains the best match, which is more likely to have a complete context while excluding irrelevant information.

FIG. 9 shows the search results 90 that the LLM 22 creates from the relevant section-based chunking. It may be noted, as opposed to the example of FIG. 7, that the entire recipe for “Best Banana Bread” is re-created in the search results 90, includes all the relevant ingredients, and includes all the relevant directions.

Thus, the chunking strategy described in the present disclosure retrieves the relevant information from a document based on the inherent structure of the document, rather than a sliding window, when performing documentation query using a RAG method. In this way, the context provided to the model would be a complete, coherent section of the document (i.e., section 84), rather than an arbitrary slice, improving the understandability of the context for the LLM 22. The server 16 and retriever 18 may be configured to perform two primary procedures-a Data Preparation procedure and an Inference (or Execution) procedure, where data preparation prepares the private information stored in the vector store 20 for searching and inference allows a query to be answered based on section-based chunking.

Data Preparation may involve ML methods and only needs to be performed once (i.e., when the data is first entered in the vector store 20). First, the Data Preparation includes breaking the document up into sections, where a section is defined as all of the content underneath a given section header. If there exists a hierarchy of subsections, the hierarchy can be flattened such that each section contains only its content (e.g., paragraphs, tables, etc.) and no subsections.

The second step of the Data Preparation procedure includes breaking the content up within each section, where it is broken up into a list of paragraphs and table entries. For tables, for convenience, the retriever 18 may extract and store the entire table as a csv file. The retriever 18 can represent each paragraph or table entry as a JSON object with its content and other keys with metadata in the vector store 20. This may include a) a header—the title of the section containing the content, b) a type—specifies whether the content comes from a table or paragraph (e.g., bullet point or numbered list entries may be considered as “paragraphs”), c) the content—the actual text of the paragraph or table entry, and d) table path—if the content comes from a table, the path to the csv representation of that table (if not a table, this is an empty string).

The third step of the Data Preparation procedure may include embedding the Content value of each paragraph or table as vectors, such as using an embedding method, and storing each Content vector along with the other metadata as columns into a relational database. It may be noted that the method of embedding the content and the specific choice of database may be implemented in any suitable manner.

The Inference procedure, for example, may be performed each time the user enters a query about the private documentation stored in the vector store 20. The Inference procedure includes a first step of embedding the user's query as a vector, and then searching the vector store 20 for the semantically closest Content vectors to the user's query. This step will yield the specific paragraph or table entry (e.g., as separated during the Data Preparation procedure), which is most similar to the question being asked. The second step of the Inference procedure includes reading the Header of the matched Content vectors, which may be referred to here as the “matched_header.” In the third step, the Inference procedure includes searching the vector store 22 for all paragraphs and tables with Header=“matched_header.” This step will yield all of the content of the particular section that contains the semantically closest Content vector. For tabular data, the procedure can read the entire table from the csv specified by “Table Path,” which may be faster than rebuilding it from the table entries. These steps are related to the section-based chunking procedure described herein. Next, the fourth step of Inference includes adding the content of the matched section to the LLM 22 prompt along with the user's query and ask the LLM 22 to answer the question using the available context.

Therefore, it is shown that the embodiments of the section-based chunking procedure provide better results relative to conventional systems. For instance, chunking documents by “section,” rather than an arbitrary sliding window, adds meaning to the retrieval of portions of private (or non-public) documentation in RAG models when a user is performing a search query of non-public information. Also, regarding data preparation, the separation of a document into paragraphs, table entries, etc. into individual objects (with metadata to specify the header, type, and table path) provides improved search results compared with conventional systems. Also, conventional systems normally do not store tabular data as csv files for retrieval during inference.

Other features are evident during the Inference procedure as well. For example, after locating the content vector with the closest match to the user query, the present disclosure uses the header metadata associated with that content vector to return the content for the entire section, which again can provide better results than conventional systems. If the section includes tables, the systems and methods of the present disclosure are configured to read those tables from their csv files and add to the context. Also, the present embodiments may include an entire relevant section as the context in the LLM prompt for documentation query, which is not provided by conventional systems.

### Process for Conducting a Query Search

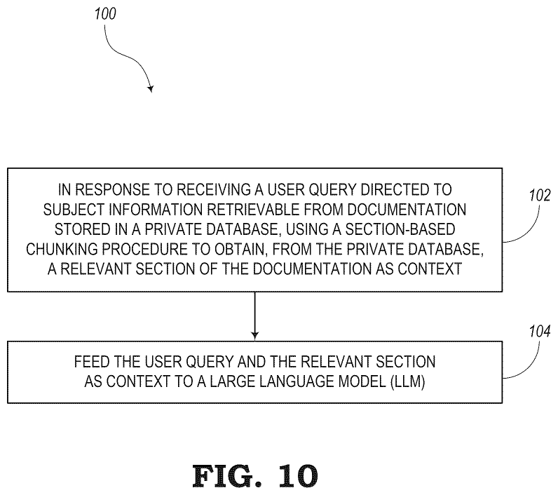

FIG. 10 is a flow diagram illustrating an embodiment of a process 100 for conducting a query search. In response to receiving a user query directed to subject information retrievable from documentation stored in a private database, the process 100 includes the step of using a section-based chunking procedure to obtain, from the private database, a relevant section of the documentation as context, as indicated in block 102. The process 100 further includes a step of feeding the user query and the relevant section as context to a Large Language Model (LLM), as indicated in block 104.

According to additional embodiments, the section-based chunking procedure described in block 102 may use a Retrieval-Augmented Generation (RAG) method to parse the user query and retrieve the relevant section. In some embodiments, the section-based chunking procedure may use an inherent structure of the documentation, such as sections, subsections, paragraphs, bullet point lists, and/or tables.

Before receiving the user query, the process 100 may further include the step of performing a data preparation procedure to separate the documentation into sections, whereby each section may include content under a respective section header. The data preparation procedure may further include a step of dividing the content of each section into one or more of paragraphs, table entries, and subsections. Also, the data preparation procedure may further include the step of embedding a content value of each section as vectors in the private database to enable the documentation to be searched by section.

In some embodiments, the process 100 may further include a step of embedding the user query as a query vector, wherein the step of obtaining the relevant section of the documentation as context may include searching the private database for the semantically closest vectors to the query vector. The step of obtaining the relevant section may also further include a) detecting a header of the semantically closest vectors and b) searching the private database for subsections having headers that match the header of the semantically closest vectors.

The section-based chunking procedure, according to some implementations, includes obtaining the relevant section of the documentation in a manner that is unrelated to the conventional sliding window procedure. In some embodiments, the size (e.g., number of characters) of the user query and relevant section is configured to fall within an input token limit (e.g., 8 k). Also, in some embodiments, the private database may be a vector store. The process 100 may be performed by the server 16 and/or retriever 18, based on various implementations.

### Example Use Case

In one example use case, the query system 10 may be hosted by a vendor for offering product or service specific answers to customer queries. Here, the vector store 20 may include product documentation which may be confidential as well as customer specific information which may also be confidential. This enables the vendor to offer meaningful answers to very specific queries, reduces support or help staff, etc. Also, this enables the vendor to update documentation independent of the training of the LLM.

### CONCLUSION

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. A non-transitory computer-readable medium configured to store a computer program having logical instructions for enabling one or more processing devices to perform the steps of:
in response to receiving a user query directed to subject information retrievable from documentation stored in a private database, using a section-based chunking procedure to obtain, from the private database, a relevant section of the documentation as context; and
feeding the user query and the relevant section as context to a Large Language Model (LLM).

2. The non-transitory computer-readable medium of claim 1, wherein the section-based chunking procedure uses Retrieval-Augmented Generation (RAG) to parse the user query and retrieve the relevant section.

3. The non-transitory computer-readable medium of claim 1, wherein the section-based chunking procedure uses an inherent structure of the documentation to select, for the relevant section, one or more of subsections, paragraphs, bullet point lists, and tables.

4. The non-transitory computer-readable medium of claim 1, wherein, before receiving the user query, the logical instructions further enable the one or more processing devices to perform a data preparation procedure to separate the documentation into sections, each section including content under a respective section header.

5. The non-transitory computer-readable medium of claim 4, wherein the data preparation procedure further includes dividing the content of each section into one or more of paragraphs, table entries, and subsections.

6. The non-transitory computer-readable medium of claim 4, wherein the data preparation procedure further includes embedding a content value of each section as vectors in the private database to enable the documentation to be searched by section.

7. The non-transitory computer-readable medium of claim 1, wherein the logical instructions further enable the one or more processing devices to embed the user query as a query vector, wherein obtaining the relevant section of the documentation as context includes searching the private database for vectors semantically closest to the query vector.

8. The non-transitory computer-readable medium of claim 7, wherein obtaining the relevant section further includes a) detecting a header of the vectors semantically closest to the query vector and b) searching the private database for subsections having headers that match the header of the vectors semantically closest to the query vector.

9. The non-transitory computer-readable medium of claim 1, wherein the section-based chunking procedure obtains the relevant section of the documentation in a manner unrelated to a sliding window procedure.

10. The non-transitory computer-readable medium of claim 1, wherein a size of the user query and relevant section is configured to fall within an input token limit of the LLM.

11. The non-transitory computer-readable medium of claim 1, wherein the private database is a vector store.

12. A method comprising the steps of:
in response to receiving a user query directed to subject information retrievable from documentation stored in a private database, using a section-based chunking procedure to obtain, from the private database, a relevant section of the documentation as context; and
feeding the user query and the relevant section as context to a Large Language Model (LLM).

13. The method of claim 12, wherein the section-based chunking procedure uses Retrieval-Augmented Generation (RAG) to parse the user query and retrieve the relevant section.

14. The method of claim 12, wherein the section-based chunking procedure uses an inherent structure of the documentation including, for the relevant section, one or more subsections, paragraphs, bullet point lists, and tables.

15. The method of claim 12, wherein, before receiving the user query, the process further comprises the steps of:
performing a data preparation procedure to separate the documentation into sections, each section including content under a respective section header;
dividing the content of each section into one or more of paragraphs, table entries, and subsections; and
embedding a content value of each section as vectors in the private database to enable the documentation to be searched by section.

16. A system comprising:
a processing device; and
memory configured to store computer logic having instructions enabling the processing device to perform the steps of:
in response to receiving a user query directed to subject information retrievable from documentation stored in a private database, using a section-based chunking procedure to obtain, from the private database, a relevant section of the documentation as context; and
feeding the user query and the relevant section as context to a Large Language Model (LLM).

17. The system of claim 16, wherein the instructions further enable the processing device to embed the user query as a query vector, wherein obtaining the relevant section of the documentation as context includes:
searching the private database for vectors semantically closest to the query vector,
detecting a header of the vectors semantically closest to the query vector, and
searching the private database for subsections having headers that match the header of the vectors semantically closest to the query vector.

18. The system of claim 16, wherein the section-based chunking procedure obtains the relevant section of the documentation in a manner unrelated to a sliding window procedure.

19. The system of claim 16, wherein a size of the user query and relevant section is configured to fall within an input token limit of the LLM.

20. The system of claim 16, wherein the private database is a vector store, and wherein the system includes one or more of a server and a retriever.
